(19) United States
(12) Patent Application Publication
(10) Pub. No.: US 2022/0172142 A1
(43) Pub. Date: Jun. 2, 2022

(54) SYSTEM AND METHODOLOGY FOR DYNAMIC ACCOUNTS IN DYNAMIC LIGHTWEIGHT PERSONALIZED ANALYTICS

(71) Applicant: Sandra K. JOHNSON, Cary, NC (US)

(72) Inventor: Sandra K. JOHNSON, Cary, NC (US)

(21) Appl. No.: 17/538,182

(22) Filed: Nov. 30, 2021

Related U.S. Application Data
(60) Provisional application No. 63/119,550, filed on Nov. 30, 2020.

(51) Int. Cl. G06Q 10/06; G06Q 40/02

(52) U.S. Cl. CPC G06Q 10/06315; G06Q 10/06393; G06Q 40/02

(57) ABSTRACT

A system and method for creating and adjusting financial accounts based on dynamic lightweight personalized analytics (DLPA) is disclosed. It provides for determining whether a user account should be suspended or deleted and considers parameters that include the number of transactions, the funds ultimately transferred, and the time between transfers. Based on these parameters and others, it can be automatically determined whether an account should be changed, including suspending the account or creating a savings account. This optimizes financial planning and increases the efficiency with which financial suggestions are provided.

### CROSS-REFERENCE TO RELATED APPLICATIONS

This application claims priority to U.S. Provisional Application No. 63/119,550, filed Nov. 30, 2020, the contents of which are incorporated herein in their entirety.

This application relates to U.S. application Ser. No. 17/365,080, filed Jul. 1, 2021, which claims priority to U.S. Application No. 63/047,326, filed on Jul. 2, 2020, and U.S. application Ser. No. 17/215,750, filed Mar. 29, 2021, which claims priority to U.S. Provisional Application No. 63/000,864, filed Mar. 27, 2020, and U.S. application Ser. No. 17/194,746, filed Mar. 8, 2021, which claims priority to U.S. Provisional Application No. 62/986,754, filed Mar. 8, 2020, and U.S. application Ser. No. 17/137,677, filed Dec. 30, 2020, which claims priority to U.S. Provisional Application No. 62/922,244, filed Dec. 30, 2019, and U.S. application Ser. No. 17/084,778, filed Oct. 30, 2020, which claims priority to U.S. Provisional Application No. 62/927,872, filed Oct. 30, 2019, and U.S. application Ser. No. 17/013,895, filed Sep. 8, 2020, which claims priority to U.S. Provisional Application No. 62/897,360, filed Sep. 8, 2019, and U.S. application Ser. No. 16/914,629, filed Jun. 29, 2020, which claims priority to U.S. Provisional Application No. 62/868,950, filed Jun. 30, 2019, the contents of which are incorporated herein in their entirety.

### FIELD OF DISCLOSURE

The present disclosure relates to a system and methodology for dynamically creating and adjusting financial accounts.

### BACKGROUND

Many consumer-based companies leverage customer behavior data and associated predictive, prescriptive, and other analytic methodologies to gain insights. Such information can translate into suggestions to improve efficiencies, understand trends, optimize customer objectives, create new potential markets, or discover or prevent fraud, to name a few. There is an abundance of analytics efforts conducted to gain such insights. With an increasingly consumer-centric society, there is a growing focus on behavioral analytics to understand customer preferences that can translate into market gains. Much of this work leverages a plethora of structured and unstructured data, big data, that may be siloed and geographically dispersed for insights.

However, there are many consumer-focused and other industries that require or benefit from small, lightweight, and fast analytics. For example, the prevailing focus in the remittance industry is the transfer of funds from sender to receiver. The transfer amounts are small, and users require minimal transfer times. Moreover, with thin industry profit margins it is important that all efforts to assist in transferring funds are efficient, lightweight, and fast. In this and many other industries, there are no significant efforts to build customer relationships, understand their preferences, needs and behaviors, and build customer loyalty leveraging small data or lightweight analytics. A study has shown that businesses that develop strong customer connections outperform their competitors by 85% in sales growth and more than 25% in gross margin (see Behavioral Economics”, Gallup, Gallup.com).

### SUMMARY OF THE DISCLOSURE

Proposed is a system and methodology for identifying, minimizing, and leveraging historic customer behavior information to optimize results in dynamic lightweight personalized analytics (DLPA). Specifically, it is used to suggest or dynamically adjust financial or other account information associated with the customer. DLPA is a new innovative technology designed to provide individual analytics to gain insights for developing personalized offerings to build relationships with the customer. DLPA leverages a limited number of customer-specific, industry-focused input parameters, other inputs such as financial and other data, and a small footprint. These parameters are placed in data structures to assist in processing DLPA-related actions. This invention focuses on dynamically adjusting the creation of accounts, funds deposited into financial accounts, and other similar metrics. It is based on customer behavior metrics used in DLPA to optimize efficiencies.

There are some efforts to use analytics in the remittance industry. For example, Remit Radar's Galileo (Galileo, https://remitradar.com/Home/Galileo) uses analytics to understand global remittance market trends. Lexis Nexis (ThreatMetrix for Money Remittance, http://threatmetrixx.com) and others use analytics to discover glitches, identify behavior anomalies, and detect fraud. Most focus on overall trends and patterns, not individual behaviors, to gain insights for unique customer offerings. To our knowledge, there are no efforts to develop dynamic lightweight personalized analytics methodologies to gain insights for customized services real time. This would be a significant game-changer, for example, in the $550B+ global cross-border remittance industry.

Aspects of the disclosed embodiments include systems and methods for dynamic accounts in dynamic lightweight personalized analytics.

Accordingly, embodiments of the present disclosure provide a system for dynamically adjusting the creation and funding of financial accounts in dynamic lightweight personalized analytics (DLPA). The system includes an interface that receives one or more inputs via an enterprise payment services bus, a data store that manages arrays of data structures comprising key performance indicators (KPIs), DLPA metrics and support data, and a dynamic lightweight personalized analytics engine comprising a computer processor and coupled to the data store and the interface. The computer processor configured to determine whether an account should be suspended or deleted, the determination comprising the steps of updating one or more parameters comprising a number of transactions (#trans), a cumulative transfer amount (cum_xfer_amount), an inter-remittance time (inter-remit time), a remittance frequency (remit freq), a maximum time between remittances before an account is changed (XFERT_THRESH), and an average transfer time (avg_xfer_tme). Next, the processor is configured to calculating the one or more of these parameters. Next, the processor is configured to determine whether a user account is active upon any one of the following being true: (1) the inter-remit time is greater than or equal to XFERT-THRESH, (2) an account value is less than or equal to the minimum balance value (MIN_BAL), or (3) analytic results suggest that the accounts should be suspended or deleted. Next, the processor is configured to delete the account upon a determination that the account is not active. Next, the processor is configured to inquire, upon a determination that the account is active, whether the account is a checking account. Finally, the account will be suspended upon a determination that the account is not a checking account.

Embodiments of the present disclosure also provide a method for dynamically adjusting the creation and funding of financial accounts in dynamic lightweight personalized analytics (DLPA). The method comprises the steps of updating one or more parameters comprising a number of transactions (#trans), a cumulative transfer amount (cum_xfer_amount), an inter-remittance time (inter-remit time), a remittance frequency (remit freq), a maximum time between remittances before an account is changed (XFERT_THRESH), and an average transfer time (avg_xfer_tme). Next, one or more of the parameters are calculated. Next, the processor determines whether a user account is active upon any one of the following being true: (1) the inter-remit time is greater than or equal to XFERT-THRESH, (2) an account value is less than or equal to the minimum balance value (MIN_BAL), or (3) analytic results suggest that the accounts should be suspended or deleted. If the account is not active, then the account is deleted. If the account is active, then the processor determines whether the account is a checking account. Finally, the account will be suspended upon a determination that the account is not a checking account.

Embodiments of the present disclosure also provide a non-transitory computer readable program instruction for dynamically adjusting the creation and funding of financial accounts in dynamic lightweight personalized analytics (DLPA). When executed on a processor, the computer executable instructions perform procedures comprising the steps of updating one or more parameters comprising a number of transactions (#trans), a cumulative transfer amount (cum_xfer_amount), an inter-remittance time (inter-remit time), a remittance frequency (remit freq), a maximum time between remittances before an account is changed (XFERT_THRESH), and an average transfer time (avg_xfer_tme). Next, one or more of the parameters are calculated. Next, the processor determines whether a user account is active upon any one of the following being true: (1) the inter-remit time is greater than or equal to XFERT-THRESH, (2) an account value is less than or equal to the minimum balance value (MIN_BAL), or (3) analytic results suggest that the accounts should be suspended or deleted. If the account is not active, then the account is deleted. If the account is active, then the processor determines whether the account is a checking account. Finally, the account will be suspended upon a determination that the account is not a checking account.

### BRIEF DESCRIPTION OF THE DRAWINGS

FIG. 1 is a block diagram of a remittance payments service-oriented architecture, in accordance with exemplary embodiments of the disclosure.

FIG. 2 is a block diagram of a remittance data storage, in accordance with exemplary embodiments of the disclosure.

FIG. 3 is a block diagram of the types of data stored in a remittance data storage, in accordance with exemplary embodiments of the disclosure.

FIG. 4 is a block diagram of the partial contents of a remittance data store, in accordance with exemplary embodiments of the disclosure.

FIG. 5 is a block diagram of the dynamic lightweight personalized analytics (DLPA) engine, including customer remittance, financial and other suggestions, in accordance with exemplary embodiments of the disclosure.

FIG. 6 is a block diagram of the dynamic lightweight personalized analytics (DLPA) remittance analytics engine, including example analysis for insights and financial suggestions, in accordance with exemplary embodiments of the disclosure.

FIG. 7 is a flowchart illustrating an exemplary method for determining when to create or suspend a financial account, in accordance with exemplary embodiments of the disclosure.

FIG. 8 is a flowchart illustrating an exemplary method for determining when to create a savings account, in accordance with exemplary embodiments of the disclosure.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Generally, the following figures describe systems and methods for creating and adjusting financial accounts. Implicit in these figures is the existence of users, financial accounts belonging to these users, and data concerning the users' personal information, consumer patterns, financial information, and other information that could potentially inform the users' future habits. By collecting and analyzing this information, the systems and methods described herein can offer suggestions and execute actions based on a predetermined set of parameters also described herein.

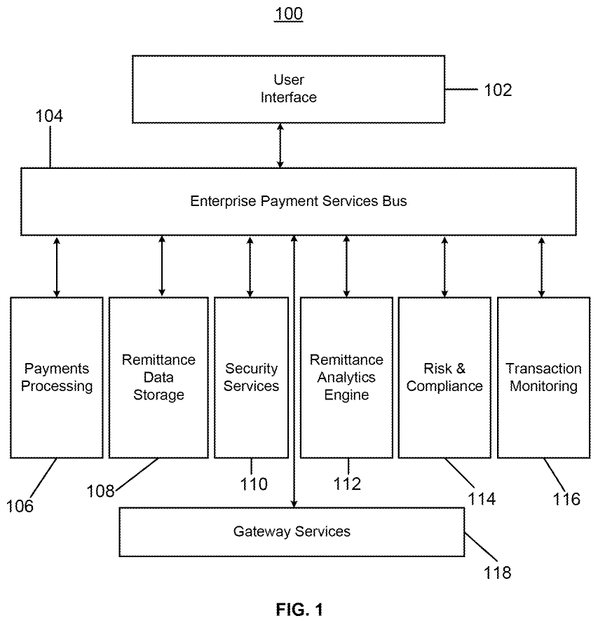

FIG. 1 is a schematic block diagram illustrating one embodiment of the service-oriented architecture (SOA) 100 of a remittance system designed to process transactions, in accordance with one embodiment of the present invention. The system 100, in one embodiment, includes a user interface 102 that enables a user to send or receive requests, etc. This user interface 102 interacts with the enterprise payments services bus 104 to request or receive services. The enterprise payments services bus 104 may be configured to transmit data between engines, databases, memories, and other components of the system 100 for use in performing the functions discussed herein.

The enterprise payments services bus 104 may be comprised of one or more communication types and utilize various communication methods for communications within a computing device. For example, the enterprise payments services bus 104 may be comprised of a bus, contact pin connectors, wires, or other similar connection devices. In some embodiments, the enterprise payments services bus 104 may also be configured to communicate between internal components of system 100 and external components accessible through gateway services 118, such as externally connected databases, display devices, input devices, or other similar devices.

There are several services that may compose this SOA 100, including payments processing 106, remittance data storage 108, security services 110, the remittance analytics engine 112, risk and compliance 114, transaction monitoring 116, and gateway services 118, which are described below. Each of these service components may be software, a computer-readable program, executing on one of more processors, and may include a mainframe computer, a workstation, a desktop computer, a computer in a smart phone, a computer system in a rack, a computer system in a cloud, a physical system, a virtual system, and the like.

The system 100, in one embodiment, is the SOA of a remittance system and is a network of software service components in which the illustrative embodiments may be implemented. The system 100 includes a user interface 102 used by a consumer. The consumer represents a person, a software program, a virtual program, or any other entity that has possession of, can emulate, or other otherwise issue commands to execute transactions in the system 100. The system 100 includes an enterprise payment services bus 104 which accepts and processes commands from the user interface 102 and other system components. It also enables communication among the various services components in the system 100.

As a part of executing a remittance request, the transaction may leverage payments processing 106 to process the request. Such processing may also include the creation and funding of financial accounts associated with a recipient. The transaction may also access remittance data storage 108 which is a resource for data access. Security services 110 are also leveraged to ensure the full security and integrity of funds and data, and to detect and prevent fraud. In addition, the remittance analytics engine 112 is leveraged and is the foundation for DLPA. This engine takes as input a plethora of information from the remittance data storage 108 and other components that may enable the remittance analytics engine 112 to optimize its outputs. The risk and compliance 114 services provide customer identification, verification and other similar services required to comply with relevant governmental regulations and to minimize risk. The transaction monitoring 116 service tracks funds transfer behavior and other activities to detect anomalies that may point to fraud. It works in concert with security services 110.

Gateway services 118 enable the transfer of funds, data, and requests to externally connected entities for further processing. Such entities may include a computer network, a financial institution, and others that may participate in end-to-end remittance or other funds transfer or data services. Other similar embodiments will be apparent to persons having skill in the relevant art.

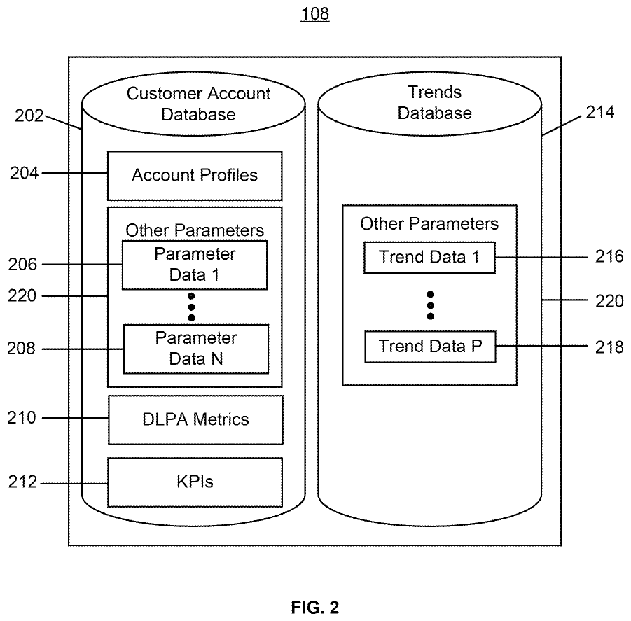

FIG. 2 is a schematic block diagram illustrating one embodiment of the remittance data storage service 108 used in the processing of information requests. The remittance data storage 108 may be a relational database, or a collection of relational databases, that utilizes structured query language for the storage, identification, modifying, updating, accessing, etc. of structured data sets stored therein. This data storage 108 is composed of a customer account database 202 that contains customer account and other related customer information. The customer account database 202 may be configured to store a plurality of consumer account profiles 204 as well as a plurality of DLPA metrics 210, including suggestions to customers 206 and 208, using a suitable data storage format and schema. Please see a larger list of potential DLPA metrics below. In addition, those skilled in the art will understand this is a representative embodiment. There are other similar metrics that may be used in other embodiments.

Each customer account profile 204 may be a structured data set configured to store data related to a remittance account. Each customer account profile 204 may include at least the customer's full name, address, telephone number, birthdate, birth country, a remittance account number, a bank account number, credit card account information, email address, a list of recipients and associated international mobile telephone numbers, remittance transaction history, a postal mailing address, an email address, and other relevant information. The customer account profile 204 may also include additional information suitable for customer service programs, customer and vendor optimizations, and regulations, such as product data, offer data, loyalty data, reward data, usage data, currency-exchange data, mobile money data, fraud scoring, validity of funds, and transaction/account controls. The customer account profile 204 may also include additional information that may be required for know-your-customer (KYC) and anti-money laundering (AML) regulations. It may further contain information suitable for performing the functions discussed herein, such as communication details for transmitting via the enterprise payment services bus 104.

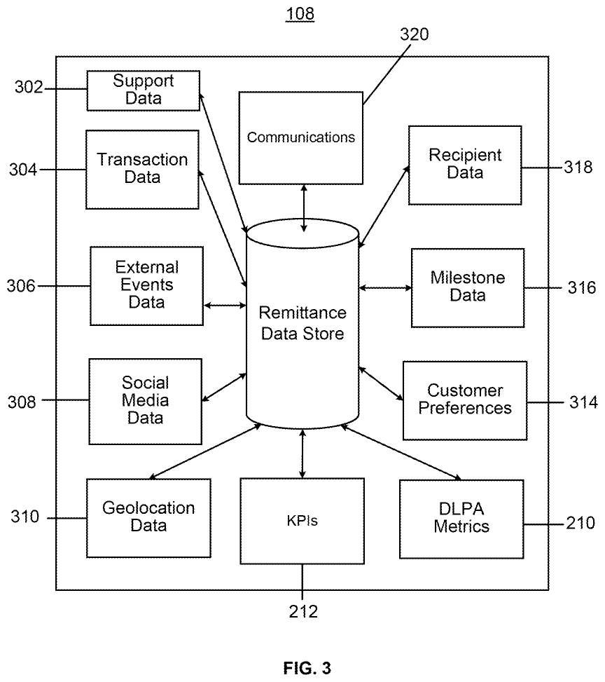

The customer parameter data 206 and 208 may be a wealth of various types or facts or other data (see FIG. 3) about the customer. Example parameter data include the number and type(s) of financial accounts associated with the customer's recipients, the associated account balances, recommendation acceptance rate (RAR), recommendation impact (RI), recommendation acceptance impact (RAI), financial account acceptance rate (FAR), financial recommendation impact (FRI), financial recommendation acceptance impact (FAI), other recommendation rate (OAR), other recommendation impact (ORI) or other recommendation acceptance impact (OAI). Please see a larger list of potential DLPA metrics below. In addition, those skilled in the art will understand this is a representative embodiment. There are other similar metrics that may be used in other embodiments.

Also contained in the customer account database 202 are other parameters 220, which includes parameter and trend data 216 and 218. This trend data is contained in a database 214. Examples of other parameters 220 include the LG-Mix, transaction data, customer temperament information, external events, social media data, geolocation data, communications data, recipient data, and milestone events. This data also includes OP-Max, the maximum number of other parameters 220 considered per customer, and OP-Count-Trigger, used to determine when to remove or replace other parameters 220. OP-Max also represents the size of the other parameter 220 array per customer. Both OP-Max and OP-Count-Trigger are default parameters that may be adjusted dynamically.

Furthermore, the customer account database 202 may include key performance indicators (KPIs) 212. Example KPIs 212 are listed below. Some include the total funds transferred per customer, the total number of transfers per customer, the total number of recipients per customer and the total balances in all financial accounts per customer.

FIG. 3 is a schematic block diagram illustrating one embodiment of specifics regarding the plurality of data that may be stored in the remittance data storage 108. This data may be stored as structured data sets that may include support data 302, transaction data 304, external events data 306, social media data 308, geolocation data 310, KPIs 212, DLPA metrics 210, customer preferences 314, milestone events 316, recipient data 318 and communications data 320.

Example support data 302 include the type of support inquiry, how it was resolved, response time, resolution time, frequency of support contact, customer satisfaction data and other similar metrics. Example transaction data 304 may include the transfer amount, transfer time, recipient name and international mobile number, the time period since the last transfer initiated by the sender to any receiver, time period since the last transfer initiated by the sender to a specific receiver, and the final status of a transaction (e.g., completed, cancelled, etc.). Additional data may include metrics to quantify customer sentiments such as the number of times or frequency that the customer contacted support, time with support, and support outcomes. Example external events 306 include general remittance transaction data (transfer amounts, frequency, etc.) for other customers using the specific remittance service or for remittance customers using any remittance service, public holidays for the sender and receiver countries, natural disasters, immigration policies, the price of oil, global and local recessions.

Example social media data 308 may include posts and other exchanges in Facebook, Twitter, Instagram, LinkedIn, and other similar social media platforms. Example geolocation data 310 may include the physical location of the sender and receiver when the funds transfer is initiated or received or the physical location of the sender or receiver at specific or random times. Other similar embodiments will be apparent to persons having skill in the relevant art.

Example customer preferences 314 are from the perspective of the sender. They may include hobbies, favorite things to do, and financial preferences. Furthermore, DLPA enables the creation of a financial or other count by the customer to save for the future. This account may be created and funded either statically or dynamically. A customer preference 314 may include the customer's desire to create a separate account (or some other activity) based on DLPA analytics, to choose the type of account to create and to determine how to fund the account.

A customer preference 314 may be to create a financial or other account when registering for the remittance service, or upon DLPA recommendations when using the remittance service. Such an account may be targeted for the customer's remittance recipients. A customer may select between a checking, savings, money market, brokerage, or other similar account. The customer may choose the purpose for creating a bank account (e.g., for education, starting a business, donating to a charity or some other option for the sender and/or the receiver). The choices may be general (e.g., the same type of account for sender and each recipient), for each recipient, or variable (e.g., a different type of account depending on the recipient or a group of recipients). Other similar embodiments will be apparent to persons having skill in the relevant art.

Example milestone events 316 may include birthdays, including milestone birthdays (e.g., 18, 25, 30, etc.), weddings, anniversaries, graduations, and other special days for the sender or receiver. Example recipient data 318 may include full name, international telephone number and recipient preferences that are like customer preferences 314. Communications data 320 may include the recent types of communications between sender, receiver, the remittance service provider, and external entities. This includes SMS messages, email, and communication types. Other similar embodiments will be apparent to persons having skill in the relevant art.

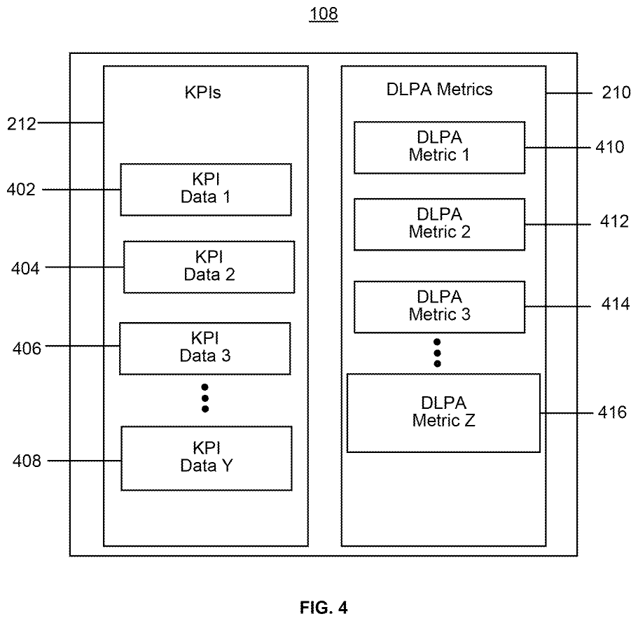

FIG. 4 108 is a schematic block diagram illustrating one embodiment of the remittance data storage that contains arrays of KPIs 212 and DLPA metrics 210. There is a plurality of KPIs 212: 402, 404, 406, and 408, contained in the remittance data storage 108. Also illustrated is a plurality of DLPA metrics 210: 410, 412, 414, and 416. These metrics are contained in the remittance data storage 108. A representative list of KPIs 212 are included below, including KPI-Max, the maximum number of KPIs 212 considered per customer and KPI-Count-Trigger, used to determine when to remove or replace a KPI 212. KPI-Max also represents the size of the KPI 212 array per customer. Both KPI-Max and KPI-Count-Trigger are adjusted dynamically, as detailed in U.S. Provisional Patent Application No. 62/927,872. Included in the DLPA metrics 210 is DLPA-Max, the maximum number of DLPA metrics 210 considered per customer and DLPA-Count-Trigger, used to determine when to remove or replace a DLPA metric 210. DLPA-Max also represents the size of the DLPA 210 array per customer. Both DLPA-Max and DLPA-Count-Trigger are adjusted dynamically, as detailed in U.S. patent application Ser. No. 17/084,778, filed on Oct. 30, 2020, the contents of which are incorporated herein by reference.

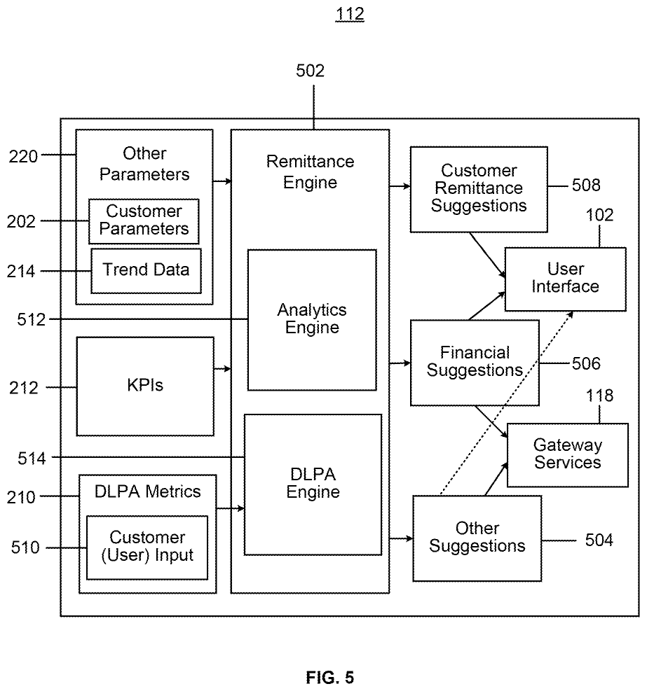

FIG. 5 is a schematic block diagram illustrating one embodiment of the remittance analytics engine 112, the foundation for DLPA. It includes at its core the remittance engine 502, which contains the analytics engine 512, and the DLPA engine 514. The remittance engine 502 accepts customer parameters 202 and remittance trends 214 as input. They collectively form the other parameters 220 set of inputs. Other input metrics accepted include the KPIs 212. The DLPA engine 514 processes DLPA-related events. It accepts DLPA metrics 210, which are impacted by responses to customer remittance suggestions 508. Such responses are contained in the customer input data 510, a component of the DLPA metrics 210. Outputs for the analytics engine 502 include customer remittance suggestions 508, financial suggestions 506 and other suggestions 504.

The customer remittance suggestions 508, financial suggestions 506 and other suggestions 504 all communicate their suggestions to the customer through the user interface 102. In addition, the financial suggestions 506 and other suggestions 504 communicate their suggestions to external entities (e.g., banks) via gateway services 118.

The analytics engine 502 is the primary computational engine for leveraging predictive, customer behavioral and other analytics techniques for optimal customer remittance suggestions 508, financial suggestions 506 and other suggestions 504 for DLPA. It further utilizes a plurality of customer parameters 202, including social media 308, support 302, and communications data 320, remittance trends 214, KPIs 212 and DLPA metrics 210 as input for its calculations. Some of the DLPA metrics 210 associated with remittance suggestions include the recommendation ratio (RR) and the financial recommendation ratio (FRR). RR is the ratio of the number of suggested remittances to the total number of remittances, suggested and traditional. FRR is the ratio of the total suggested remittance amounts to the total funds in remittance accounts.

Customer remittance suggestions 508 may include recommendations for sending additional funds to one or a plurality of recipients, increasing the frequency of sending funds to one or a plurality of recipients, or other similar suggestions. Moreover, the customer may agree to specific transfer amounts and frequency, based on certain analytics triggers, customer registration, by default or dynamically. Financial suggestions 506 may include creating one or a plurality of finance accounts, based on customer preferences 314. The number of accounts may be determined upon customer registration for the remittance service, by default, or dynamically. The number or frequency of other suggestions 504 may be determined in a similar manner.

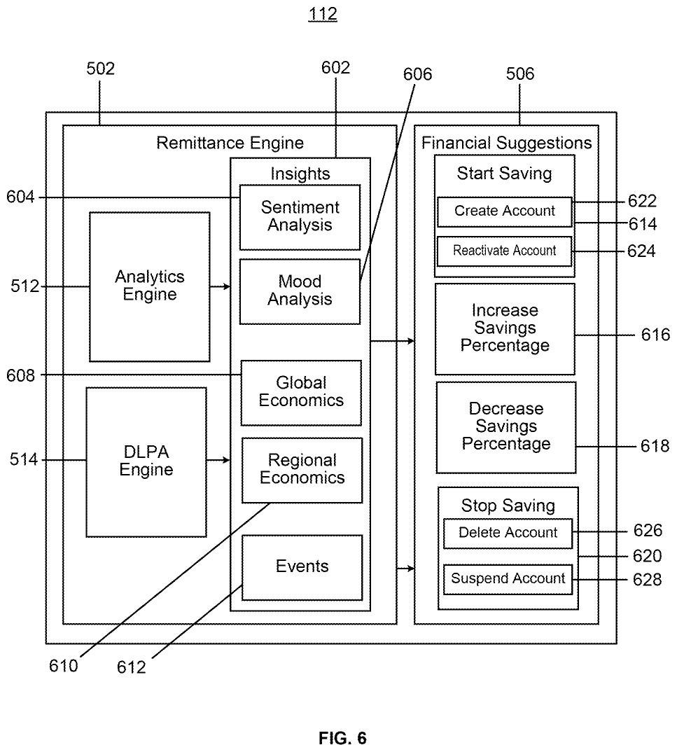

FIG. 6 is a schematic block diagram illustrating an exemplary method for the remittance analytics engine 112. It includes the core remittance engine 502, which includes the analytics engine 512 and the DLPA engine 514. In addition, it includes insights 602 obtained from sentiment analysis 604, mood analysis 606, global economic data 608, regional economic data 610 and other events 612, such as customer milestone events 316. Other embodiments may show other similar analysis methods for assessing customer behavior or mood, as well as other external factors impacting financial account behavior.

These insights 602 are then provided as input in the remittance engine 502 to provide financial suggestions 506 to the customer. Exemplary suggestions 506 include starting a savings account 614, creating a financial account 622, or reactivating an account 624. Suggestions also include increasing 616 or decreasing 618 the percentage of the funds transfer fee to deposit into the account or stopping the deposit of funds into the account 620. Furthermore, it may include deleting the account 626 or suspending the account 628.

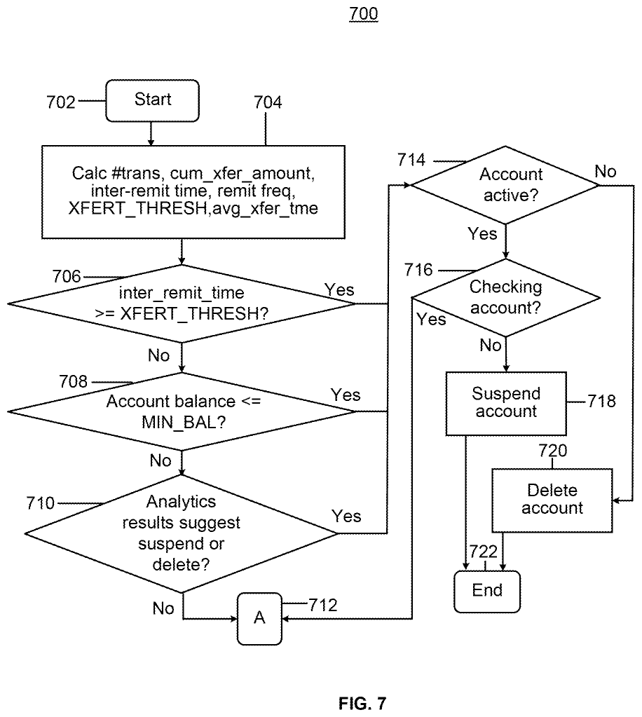

FIG. 7 is a flowchart illustrating an exemplary method for determining whether to close or suspend an account. The method starts 702 by updating several parameters, including the number of transactions (#trans), the cumulative transfer amount (cum_xfer_amount), the inter-remittance time, the remittance frequency, and the average transfer time (avg_xfer_tme). These parameters are initially reset to 0. The number of transactions is the total number of remittances sent by the customer since the last time the number was set. This number may be incremented once per customer transfer (independent of the intended recipient) or once for transfers from the customer to a specific receiver. cum_xfer_amount is the cumulative sum of the amount of funds transferred since this parameter was last set. Like #trans, this number can be per customer, independent of the number of recipients, or for each customer-recipient pair. The inter-remittance time is the time between two consecutive remittances. The remittance frequency is the number of remittances (or transactions), per customer or per customer-recipient pair, within a given time window. The value of this time window can be a default value, the inter-remittance time, or dynamically determined. Those skilled in the art will know that the time window can also be the time elapsed since #trans or cum_xfer_amount was reset. Likewise, #trans and cum_xfer_amount may be reset after a given time window. The average transfer time is the average time between remittances.

XFERT_THRESH is a default or dynamically determined parameter that specifies the maximum time between remittances before an account is changed (e.g., from checking to savings), suspended, or closed. Another embodiment is to have separate XFERT-THRESH parameters, one each for changing, suspending, or closing an account. This may be one account per customer or several accounts per customer with each account associated with a specific recipient (or a collection of recipients). The MIN BAL is the minimum balance required for an account before suspending or closing. This parameter may also be a default or dynamically determined. In addition, a separate embodiment may have different values for MIN_BAL, one each for the types of accounts (e.g., checking, savings, suspended).

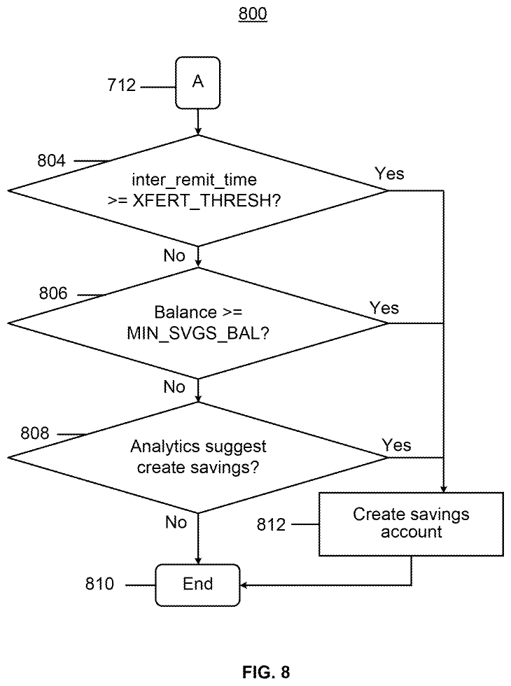

Once these parameters are calculated 704, the method checks whether the inter-remittance time is greater than or equal to XFERT_THRESH 706. It is set as a default value or by the customer (for all recipients or per recipient). If no, then it checks to determine if the account balance is less than or equal MIN_BAL 708. If no, then it determines if any analytics results suggest the account be suspended of deleted 710. If no, then proceeds to the next step 712, which is described in FIG. 8 800.

If the answer to any of the three previous questions 706, 708, or 710 is yes, then the method determines if the account is active 714. If yes, then it inquires whether it is a checking account 716. If yes, then it proceeds to determine what to do with the savings account, which is the next step 712 described in FIG. 8. If the account is not active, then it is deleted 720 and the process ends 722. If the account is not a checking account, then it is suspended 718 and the process ends 722.

FIG. 8 800 is a flowchart illustrating an exemplary method for determining when to create a savings account. The method starts 712 by determining if the inter-remittance time is greater than or equal to XFERT_THRESH 804. If this is not the case, then the balance is compared to the minimum savings balance 806. MIN_SVGS_BAL is the minimum balance required for a savings account before suspending or closing. This parameter may also be a default or dynamically determined. In addition, a separate embodiment may have different values for MIN_SVGS_BAL, one each for the types of accounts (e.g., checking, savings, suspended).

If the balance is not greater than or equal to MIN_SVGS_BAL 806, then the method checks to determine if any analytics insights have suggested creating a savings account 808. If this is not the case the method ends 810. If the result of any of the three previously described inquiries 804, 806, or 808 is yes, then the savings account is created 812 and the process ends 810.

In reference to the aforementioned descriptions, an algorithm can mean a set of steps or rules that enables the solution to an issue.

Analytics can mean a methodology for discovering, understanding, and communicating meaningful patterns in data.

Architecture can mean the fundamental structures of a system and the associated discipline for creating such structures.

Communications data can mean information deriving from the customer's communications, include SMS messages and email.

Regarding the parameters used in DLPA methodology, the following definitions are provided:
RAR: recommendation acceptance rate; the fraction of all recommendations per customer accepted;
RI: recommendation impact; the fraction of all recommendations resulting in an increase in at least one KPI (new KPI value>=current KPI value) in KPI-Array;
RAI: acceptance impact; the fraction of all customer accepted recommendations resulting in an increase in at least one KPI in KPI-Array;
FAR: financial account acceptance rate; the fraction of all financial account recommendations per customer accepted;
FRI: financial recommendation impact; fraction of all financial account recommendations resulting in an increase in at least one KPI in KPI-Array;
FAI: finance recommendation acceptance impact; fraction of all accepted financial account recommendations resulting in an increase in at least one KPI in KPI-Array;
OAR: other recommendations acceptance rate; the fraction of all other recommendations per customer accepted;
ORI: other recommendations impact; fraction of all non-financial-account recommendations resulting in an increase in at least one KPI in KPI-Array;
OAI: other recommendations acceptance impact; fraction of all accepted non-financial-account recommendations resulting in an increase in at least one KPI in KPI-Array;
RR: Recommendation Ratio is a ratio of the number of suggested remittances to the total number of remittances (suggested plus traditional);
FRR: Financial Recommendation Ratio is a ratio of the total suggested remittance amounts in accounts to the total number of funds in accounts;
Rec-Array: an array of past recommendations to the customer, including the type of recommendation (e.g., financial or other), and whether accepted;
Rec-Array-Max: the maximum number of entries in the Rec-Array;
CIS: Change in Savings is the change in the total savings amounts per customer, or per recipient per customer, between time windows;
DLPA-Array: a collection the DLPA metrics of focus per customer, and whether it favourably impacted each KPI per customer;
DLPA-Count-Trigger: used to determine when to remove or replace a DLPA metric;
DLPA-Max: the maximum number of DLPA metrics considered per customer; and
REMOVE: a flag to determine whether to remove or replace a DLPA metric in DLPA-Array.

Regarding key performance indicators (KPIs) described herein, the following definitions are provided:
TFT: Total funds transferred per customer (sender);
TFT-Min: the minimum value for TFT;
TNT: Total number of transfers per customer;
TB: Total balances in all financial accounts per customer;
TB-Min: the minimum value for TB;
NR: Total number of recipients per customer;
NFA: Total number of financial accounts per customer;
KPI-Array: a collection the KPIs of focus per customer;
KPI-Max: the maximum number of KPIs considered per customer;
KPI-Count-Trigger: used to determine when to remove or replace a KPI; and
LG-Mix can mean a fraction of all DLPA suggestions (local and global) that are local.

Other parameters include DLPA parameter and trend data described in U.S. patent application Ser. No. 16/914,629, filed Jun. 29, 2020, the contents of which are incorporated by reference herein in their entirety. Examples include the LG-Mix, transaction data, external events, social media data, geolocation data, communications data, recipient data, milestone events, trend data, etc.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labelled as modules, to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

1. A system for dynamically adjusting the creation and funding of financial accounts in dynamic lightweight personalized analytics (DLPA), the system comprising:
an interface that receives one or more inputs via an enterprise payment services bus;
a data store that manage arrays of data structures comprising key performance indicators (KPIs), DLPA metrics and support data; and
a dynamic lightweight personalized analytics engine comprising a computer processor and coupled to the data store and the interface, the computer processor configured to determine whether an account should be suspended or deleted, the determination comprising:
updating one or more parameters comprising: a number of transactions (#trans), a cumulative transfer amount (cum_xfer_amount), an inter-remittance time (inter-remit time), a remittance frequency (remit freq), a maximum time between remittances before an account is changed (XFERT_THRESH), and an average transfer time (avg_xfer_tme);
calculating the one or more parameters;
determining whether a user account is active upon any one of the following being true: (1) the inter-remit time is greater than or equal to XFERT-THRESH, (2) an account value is less than or equal to the minimum balance value (MIN_BAL), or (3) analytic results suggest that the accounts should be suspended or deleted;
deleting the account upon a determination that the account is not active;
inquiring, upon a determination that the account is active, whether the account is a checking account;
suspending the account upon a determination that the account is not a checking account.

2. The system of claim 1, wherein the #trans is the total number of remittances sent by the customer since the last time the number was set.

3. The system of claim 1, wherein the cum_xfer_amount is the cumulative sum of the amount of funds transferred since this parameter was last set.

4. The system of claim 1, wherein the inter-remit time is the time between two consecutive remittances.

5. The system of claim 1, wherein the remit freq is the number of remittances or transactions per customer in a given time window, wherein the given time window is one of a default value, the inter-remittance time, or dynamically determined.

6. The system of claim 1, wherein the XFERT_THRESH is the maximum time between remittances before an account is changed, suspended, or closed.

7. The system of claim 1, wherein the MIN_BAL is a different value for each checking, savings, or suspended accounts.

8. The system of claim 1, the determination further comprising:
create, upon a determination that an account is a checking account, a savings account upon any one of the following being true: (1) inter_remit_time is greater than or equal to XFERT_THRESH, (2) the balance is greater than or equal to MIN_SVGS_BAL, or (3) any analytics insights suggest creating a savings account.

9. A method for dynamically adjusting the creation and funding of financial accounts in dynamic lightweight personalized analytics (DLPA), the method comprising:
updating one or more parameters comprising a number of transactions (#trans), a cumulative transfer amount (cum__xfer_amount), an inter-remittance time (inter-remit time), a remittance frequency (remit freq), a maximum time between remittances before an account is changed (XFERT_THRESH), and an average transfer time (avg_xfer_tme);
calculating the one or more parameters;
determining whether a user account is active upon any one of the following being true: (1) the inter-remit time is greater than or equal to XFERT-THRESH, (2) an account value is less than or equal to the minimum balance value (MIN_BAL), or (3) analytic results suggest that the accounts should be suspended or deleted;
deleting the account upon a determination that the account is not active;
inquiring, upon a determination that the account is active, whether the account is a checking account; and
suspending the account upon a determination that the account is not a checking account.

10. The method of claim 9, wherein the #trans is the total number of remittances sent by the customer since the last time the total number was set.

11. The method of claim 9, wherein the cum_xfer_amount is the cumulative sum of the amount of funds transferred since this parameter was last set.

12. The method of claim 9, wherein the inter-remit time is the time between two consecutive remittances.

13. The method of claim 9, wherein the remit freq is the number of remittances or transactions per customer in a given time window, wherein the given time window is one of a default value, the inter-remittance time, or dynamically determined.

14. The method of claim 9, wherein the XFERT_THRESH is the maximum time between remittances before an account is changed, suspended, or closed.

15. The method of claim 9, wherein the MIN_BAL is a different value for each checking, savings, or suspended accounts.

16. The method of claim 9, the method further comprising:
creating, upon a determination that an account is a checking account, a savings account upon any one of the following being true: (1) inter_remit_time is greater than or equal to XFERT_THRESH, (2) the balance is greater than or equal to MIN_SVGS_BAL, or (3) any analytics insights suggest creating a savings account.

17. A non-transitory computer readable medium comprising computer executable instructions that, when executed on a processor, perform steps comprising:
updating one or more parameters comprising a number of transactions (#trans), a cumulative transfer amount (cum_xfer_amount), an inter-remittance time (inter-remit time), a remittance frequency (remit freq), a maximum time between remittances before an account is changed (XFERT_THRESH), and an average transfer time (avg_xfer_tme);
calculating the one or more parameters;
determining whether a user account is active upon any one of the following being true: (1) the inter-remit time is greater than or equal to XFERT-THRESH, (2) an account value is less than or equal to the minimum balance value (MIN_BAL), or (3) analytic results suggest that the accounts should be suspended or deleted;
deleting the account upon a determination that the account is not active;
inquiring, upon a determination that the account is active, whether the account is a checking account;
suspending the account upon a determination that the account is not a checking account.

18. The non-transitory computer readable medium of claim 19 wherein the #trans is the total number of remittances sent by the customer since the last time the number was set; the cum_xfer_amount is the cumulative sum of the amount of funds transferred since this parameter was last set; the inter-remit time is the time between two consecutive remittances; the remit freq is the number of remittances or transactions per customer in a given time window; the XFERT_THRESH is the maximum time between remittances before an account is changed, suspended, or closed, and the MIN_BAL is a different value for each checking, savings, or suspended accounts.

19. The non-transitory computer readable medium of claim 20 wherein the given time window is a default value, the inter-remittance time, or dynamically determined.

20. The non-transitory computer readable medium of claim 19, the steps further comprising:
creating, upon a determination that an account is a checking account, a savings account upon any one of the following being true: (1) inter_remit_time is greater than or equal to XFERT_THRESH, (2) the balance is greater than or equal to MIN_SVGS_BAL, or (3) any analytics insights suggest creating a savings account.
